(19) United States
(12) Patent Application Publication
(10) Pub. No.: US 2015/0109945 A1
(43) Pub. Date: Apr. 23, 2015

(54) ON-DEMAND TRANSMISSION PATH PROVIDING SYSTEM AND METHOD

(71) Applicant: POWER-ALL NETWORKS LIMITED, Shatin (HK)

(72) Inventors: Kai ZHOU, Wuhan (CN); Hai-Tao LI, Wuhan (CN); Mao-Hua HE, Wuhan (CN)

(21) Appl. No.: 14/511,854

(22) Filed: Oct. 10, 2014

(30) Foreign Application Priority Data
Oct. 18, 2013 (CN) 201310490126.7

(51) Int. Cl. H04L 12/24

(52) U.S. Cl. CPC H04L 41/5051; H04L 41/22; H04L 41/5009; H04L 41/0896
USPC 370/252

(57) ABSTRACT

An on-demand transmission path providing method includes: receiving a virtual lease line (VLL) establishing request including a start area and an end area of the VLL and an establishing duration of the VLL; producing a VLL establishing information including a connection relationship of router devices constituting the VLL and ports of the router devices to be connected; assigning a timed task for the VLL according to the establishing duration, therein, the timed task includes a start time and an end time when establishing the VLL; judging whether current time reaches to the beginning time of the timed task; and establishing the VLL if yes.

### CROSS-REFERENCE TO RELATED APPLICATIONS

This application claims priority to Chinese Patent Application No. 201310490126.7 filed on Oct. 18, 2013, the contents of which are incorporated by reference herein. This application is related to the following co-pending, commonly assigned patent applications, the disclosures of which are incorporated herein by reference in their entirety:

1. “NETWORK SYSTEM CAPABLE OF ENHANCING CONNECTION PERFORMANCE” by Zhou et al., whose Attorney Docket No is US53458.

2. “TRANSMISSION PATH CONTROL DEVICE” by Zhou et al., whose Attorney Docket No is US53454.

3. “TRANSMISSION PATH MANAGEMENT SYSTEM AND METHOD” by Zhou et al., whose Attorney Docket No is US53456.

4. “ TRANSMISSION PATH CONTROL SYSTEM” by Zhou et al., whose Attorney

Docket No is US53443.

5. “TRANSMISSION PATH MANAGEMENT DEVICE” by Zhou et al., whose Attorney Docket No is US53453.

6. “TRANSMISSION PATH MANAGEMENT SYSTEM AND METHOD” by Zhou et al., whose Attorney Docket No is US53457.

### FIELD

The present disclosure relates to transmission path systems, and particularly to a on-demand transmission path providing system, and a method thereof.

### BACKGROUND

Electronic devices, such as mobile phones and tablet computers, are common and widespread in use. Generally, the electronic devices can communicate with each other via corresponding networks, such as the internet, a code division multiple access (CDMA) network, or a broadcasting network. However, in some situations, such as when a user is transmitting a large sized file with an electronic device but the electronic device is connected to a narrow bandwidth network, a resulting access speed may be very slow.

### BRIEF DESCRIPTION OF THE DRAWINGS

Implementations of the present technology will now be described, by way of example only, with reference to the attached figures.

FIG. 1 is a block diagram of an on-demand transmission path providing system.

FIG. 2 is a diagrammatic view of a management server connected to a number of local network devices.

FIG. 3 is a diagrammatic view of a user interface.

FIG. 4 is a diagrammatic view of a connection relationship of router devices constituting a transmission path.

FIG. 5 is a diagrammatic view of a timed task list.

FIG. 6 is a flowchart diagram of an on-demand transmission path providing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

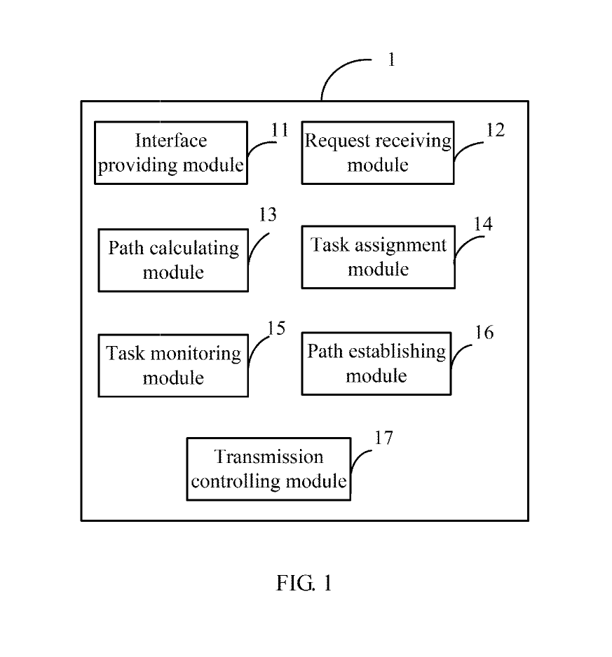

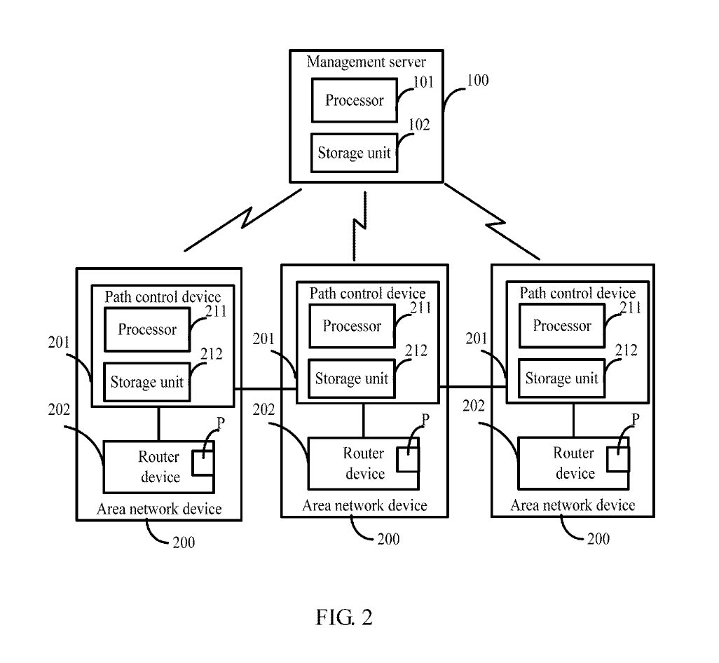

Referring to FIG. 1 and FIG. 2, an on-demand transmission path providing system 1 is illustrated. The transmission path management system 1 is run in at least one management server 100 and a number of local network devices 200. Each local network device 200 is located in a corresponding area, specially, located in a corresponding geographic area. For example, one local network device 200 is located in New York, another local network device 200 is located in Philadelphia. In the embodiment, each local network device 200 can be an Internet Data Center (IDC) constituted by a number of computing devices. The on-demand transmission path providing system 1 is used to provide an on-demand transmission path, in the embodiment, the on-demand transmission path is an on-demand virtual lease line (VLL).

In the embodiment, as shown in FIG. 2, each local network device 200 at least includes a path control device 201 and a router device 202 connected to the path control device 201. Hereinafter, for simplicity, the router device 202 connected to the path control device 201 is represented as the router device 202 corresponding to the path control device 201. Each router device 202 includes a number of ports P. The management server 100 communicates with the path control devices 201 via corresponding networks. Each two path control devices 201 are also communicated to each other via corresponding networks. The network can be Internet, a wireless network including WIFI and BLUETOOTH, a telecommunication network including a general packet radio service (GPRS) network and a code division multiple access (CDMA) network, a broadcasting network, and the like. The network between the management server 100 and the path control device 201 and the network between the each two path control devices 201 can be the same or different.

The management server 100 includes a processor 101 and a storage unit 102. Each path control device 201 also includes a processor 211 and a storage unit 212. The management server 100 can be a single server or a server group. The path control device 201 can be a computing device, such as a personal computer or a server. The router device 202 can be a router, a switch, or a gateway.

The on-demand transmission path providing system 1 includes an interface providing module 11, a request receiving module 12, a path calculating module 13, a task assignment module 14, a task monitoring module 15, a path establishing module 16, and a transmission controlling module 17.

In the embodiment, the interface providing module 11, the request receiving module 12, the task assignment module 14, and the task monitoring module 15 can be collections of software instructions stored in the storage unit 102 of the management server 100 and executed by the processor 101 of the management server 100. The path calculating module 13 can be collections of software instructions stored in the storage unit 212 of the path control device 201 and executed by the processor 211 of the path control device 201. The path establishing module 16 and the transmission controlling module 17 can be collections of software instructions stored in the storage unit 102 of the management server 100 or the storage unit 212 of the path control device 201 and executed by the processor 101 of the management server 100 or the processor 211 of the path control device 201. The modules of the on-demand transmission path providing system 1 also can include functionality represented as hardware or integrated circuits, or as software and hardware combinations, such as a special-purpose processor or a general-purpose processor with special-purpose firmware.

In another embodiment, the all of modules of the on-demand transmission path providing system 1 can be collections of software instructions stored in the storage unit 102 of the management server 100 and executed by the processor 101 of the management server 100.

In one embodiment, each one of the processors 101, 211, can be a central processing unit, a digital signal processor, or a single chip, for example. In one embodiment, each one of the storage units 102, 212 can be an internal storage system, such as a flash memory, a random access memory (RAM) for temporary storage of information, and/or a read-only memory (ROM) for permanent storage of information. Each one of the storage units 102, 212 can also be a storage system, such as a hard disk, a storage card, or a data storage medium. Each one of the storage units 102, 212 can include volatile and/or non-volatile storage devices. In at least one embodiment, each one of the storage units 102, 212 can include two or more storage devices such that one storage device is a memory and the other storage device is a hard drive. Additionally, one or more of the storage units 102, 212 can be respectively located either entirely or partially external relative to the management server 100, and the path control device 201.

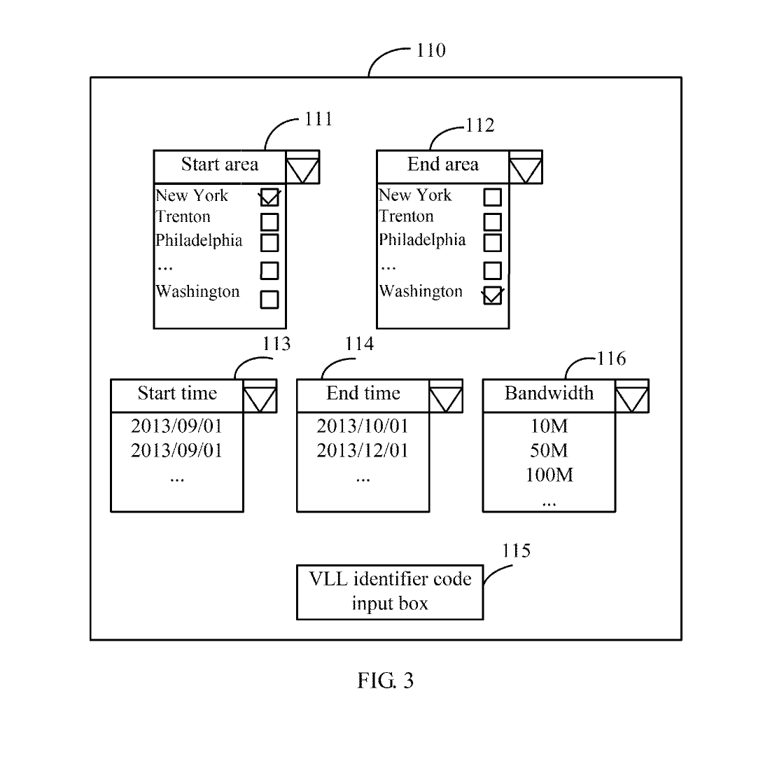

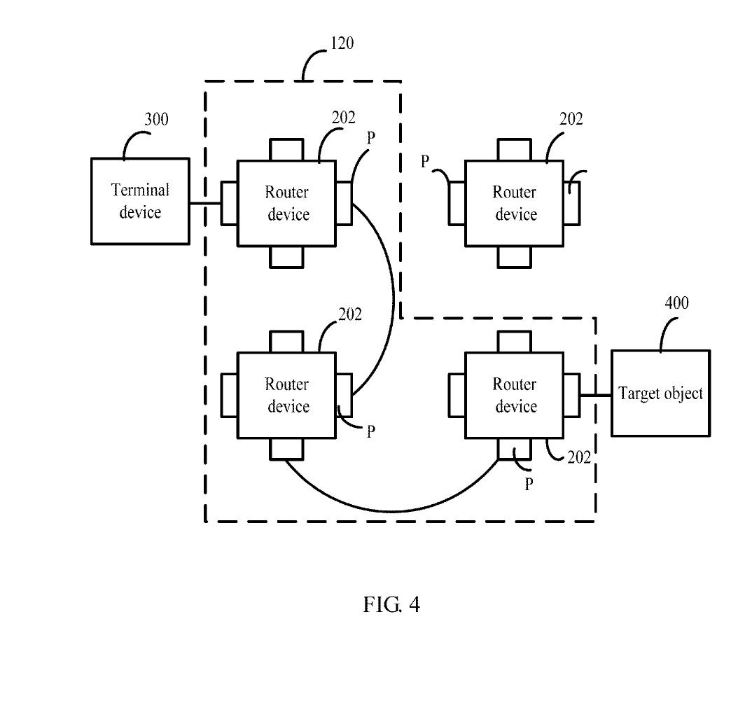

Referring also to FIG. 3 and FIG. 4, the interface providing module 11 is used to provide a user interface 110 provided for a user to input a start area, an end area, a state time, and an end time of a VLL 120 to be established. In detail, the user interface 110 at least includes a start input box 111, an end input box 112, a start time input box 113, an end time input box 114. The start input box 111 is provided to input or select the start area of the VLL 120, and the end input box 112 is provided to input or select the end area of the VLL 120. The start time input box 113 is provided to input or select the start time of the VLL 120, and the end time input box 114 is provided to input or select the end time of the VLL 120. The interface providing module 11 can provide the user interface 110 when the user logs in a login webpage for the user interface 110 successfully. As shown in FIG. 3, the start input box 111, the end input box 112, the start time input box 113, and the end time input box 114 are drop-down list boxes, and can provide a list including a number areas in response to user operations. In another embodiment, the start input box 111, the end input box 112, the start time input box 113, and the end time input box 114 also can be provided to input the start area or the end area directly.

The request receiving module 12 is used to receive a VLL establishing request provided by an operation on the user interface 110 by the user. In detail, the operation on the user interface 110 by the user can be that the user inputs or selects the start area, the end area, the start time, and the end time respectively via the start input box 111, the end input box 112, the start time input box 113, and the end time input box 114. Therefore, when the user wants to establish the VLL 120, the user can input or select the start area, the end area, the start time, and the end time of the VLL 120 via the user interface 110 to produce the VLL establishing request. The VLL establishing request includes information of the start area, the end area, the start time, and the end time of the VLL 120.

The path calculating module 13 is used to determine which router devices 202 are transmission ports constituting the VLL 120 and which ports P of each router device 202 determined as the transmission nodes of the VLL 120 are ports P to be connected to another port P of the router devices 202 determined as the transmission nodes to form the VLL 120, and generate VLL establishing information including the ports P to be connected and connection relationships between the router devices 202 determined as the transmission nodes of the VLL 120. The related technology of generating the VLL establishing information are disclosed in a related patent applications whose attorney docket No. are US53456, US53457, and US53453. The connection relationships between the router devices 202 determined as the transmission nodes of the VLL 120 can include positions of the router devices 202 determined as the transmission nodes of the VLL and information of which router devices 202 determined as the transmission nodes of the VLL 120 are adjacent router devices for each router device 202 determined as the transmission nodes of the VLL 120.

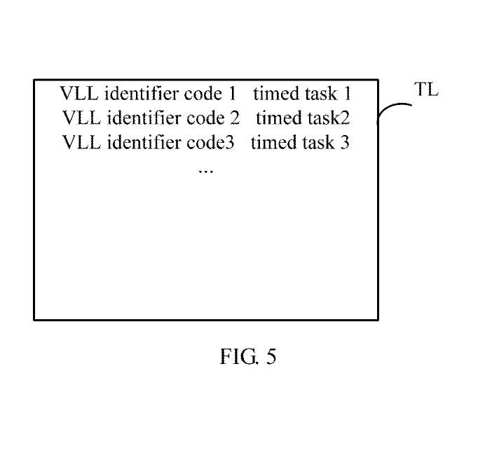

Referring also to FIG. 5, the task assignment module 14 is used to assign a timed task for the VLL 120 to be established according to the start time and the end time of the VLL 120. The timed task can be a task to establish one corresponding VLL 120 and includes information of the start time and the end time within which the VLL 120 is established. The task assignment module 14 further associates the timed task of the VLL 120 with a VLL identifier code of the VLL 120 and adds the associated timed task and the VLL identifier code to a timed task list TL. As shown in FIG. 5, the timed task list includes a number of VLL identifier codes and corresponding timed tasks, each VLL identifier code corresponds to one VLL. Thus, the timed task list includes a number of timed tasks of different VLLs 120, and the timed task for each VLL includes the start time and the end time of the VLL and is the task to establish the VLL 120 corresponding to the VLL identifier code.

In the embodiment, the user interface 110 also includes a VLL identifier code input box 115. The VLL identifier code input box 115 is provided to input or select one VLL identifier code for the VLL 120 to be established. For example, when the user generates the VLL establishing request to request to establish the VLL 120 via the user interface 110 as described above, the user can further input or select the VLL identifier code for the VLL 120 to be established. The task assignment module 14 associates the timed task of the VLL 120 with the VLL identifier code input or selected by the user and adds the associated timed task and VLL identifier code to the timed task list TL. In another embodiment, the task assignment module 14 can assign a unique VLL identifier code to the VLL 120 automatically, and then associates the VLL identifier code with the timed task of the VLL 120.

The task monitoring module 15 is used to monitor the timed task of each VLL 120 of the timed task list TL, and determine whether current time reaches the start time of one VLL 120.

When the current time reaches the start time of one VLL 120, the path establishing module 16 connects the ports P to be connected of the router device 202 determined as the transmission nodes of the corresponding VLL 120 one by one according to the VLL establishing information.

In detail, the path establishing module 16 labels the ports P to be connected of each router device determined as the transmission node of the VLL 120 by using the VLL identifier code, and connects the ports P labeled with the VLL identifier code one by one according to the connection relationships of the router devices 202 determined as the transmission nodes of the VLL 120. Namely, the path establishing module 16 connects the ports P labeled with the VLL identifier code of the corresponding router devices 202 adjacent to each other one by one to establish the VLL 120.

In the embodiment, the task monitoring module 15 further monitors the timed task of each VLL 120 of the timed task list TL to determine whether current time reaches the end time of one VLL 120. When the current time reaches the end time of one VLL 120, the path establishing module 16 controls to cancels the VLL 120. In detail, the task monitoring module 15 sends a cancelling command to the path establishing module 16, and the path establishing module 16 clears the corresponding VLL identifier code from the ports P of the router device 202 determined as the transmission nodes of the VLL 120, and recovers an initial configuration for the ports P, thus to cancel the VLL 120.

In one embodiment, the user interface 110 further includes a bandwidth input box 116, the bandwidth input box 116 is provided to input or select a bandwidth for the VLL 120 to be established. For example, the user can input or select the bandwidth as 10 megabit/second (M/s), 50 M/s, or the like.

In one embodiment, the timed task assigned by the task assignment module 14 further includes the bandwidth of the VLL 120 to be established.

The path establishing module 16 configures the ports P to be connected according to the bandwidth of the VLL 120 included in the timed task of the VLL 120. In detail, the path establishing module 16 configures the ports P to be connected can provide the corresponding bandwidth. Therefore, the VLL 120 constituted by connecting the ports P to be connected one by one can have the corresponding bandwidth.

Therefore, in the present disclosure, the VLL 120 can be established according to the required time period, namely during the start time and the end time input or selected by the user. The VLL 120 also can provide the corresponding bandwidth according to the requirement of the user.

As shown in FIG. 4, the path establishing module 16 is used to connect the port P labeled with the VLL identifier code one by one according to port connection information of each port P to be connected, thus to establish the VLL. In the embodiment, the path establishing module 19 determines which ports P that each port P needs to connect according to the positions of the router devices 202 constituting the VLL, thus to obtain the port connection information for each port P. Namely, the port connection information for each port P includes the information of ports P that the each port P connects to.

As shown in FIG. 4, the path establishing module 16 further establishes a connection between the router device 202 located in the start area and the terminal device 300 of the user generating the VLL establishing request. The path establishing module 19 further establishes a connection between the router device 202 located in the end area and a target object 400. Therefore, the terminal device 300 is connected to the target object 400 via the VLL 120. In the embodiment, the target object 400 can be another terminal device 300 or a network, such as a private network, Internet, or the like.

In one embodiment, the task assignment module 14 further can change the start time and/or the end time of one VLL 120 of the timed task list TL in response to a change request for changing the start time and the end time of the VLL 120 from the user. In the embodiment, the task assignment module 14 can change the start time and the end time of one VLL 120 of the timed task list TL before the VLL 120 is established, and can change the end time of the VLL 120 of the timed task list TL after the VLL 120 is established. Accordingly, the path establishing module 16 controls to establish the VLL 120 or cancel the VLL 120 according to the changed start time and/or the end time of the VLL 120.

In one embodiment, the task assignment module 14 further can change the bandwidth of one VLL 120 of the timed task list TL in response to a change request for changing the bandwidth of the VLL 120 from the user. The path establishing module 16 can reconfigure the ports P to be connected according to the changed/updated bandwidth of the VLL 120 included in the timed task of the VLL 120, and the VLL 120 can provide the changed bandwidth accordingly.

The transmission controlling module 17 is used to label data transmitted by the user by using the VLL identifier code, and control the data to transmit via the ports P labeled with the same VLL identifier code when transmitting the data via the router device 202 constituting the VLL. In the embodiment, each VLL identifier code further corresponds to an identity of a user, when one user starts to transmit the data, the transmission controlling module 20 obtains the identity of the user and determines the VLL identifier code corresponding to the identity of the user, and then labels the data to be transmitted by using the VLL identifier code. The identity of the user can be a user name which the user used to log in the user interface 110, or an identity card number of the user.

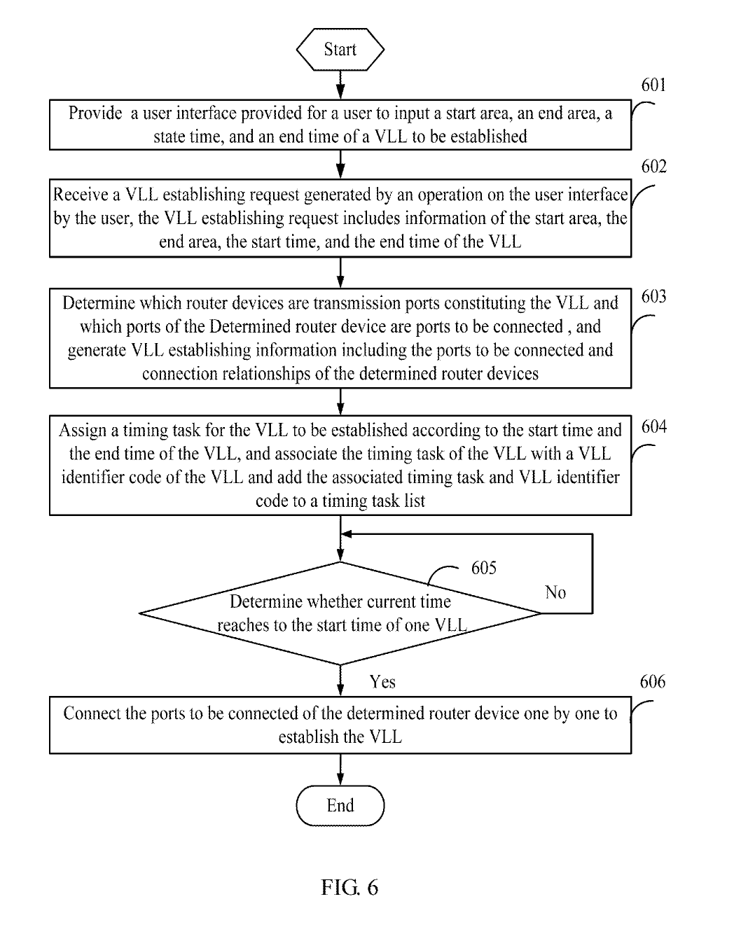

FIG. 6 illustrates a flowchart of a on-demand transmission path providing method. The method is provided by way of example, as there are a variety of ways to carry out the method. The method described below can be carried out using the configurations illustrated in FIG. 1, for example, and various elements of these figures are referenced in explaining the example method. Each block shown in FIG. 6 represents one or more processes, methods, or subroutines carried out in the example method. Additionally, the illustrated order of blocks is by example only and the order of the blocks can be changed. The example method can begin at block 601.

In block 601, an interface providing module provides a user interface provided for a user to input a start area, an end area, a state time, and an end time of a VLL to be established. In detail, the user interface at least includes a start input box, an end input box, a start time input box, an end time input box. The start input box is provided to input or select the start area of the VLL, and the end input box is provided to input or select the end area of the VLL. The start time input box is provided to input or select the start time of the VLL, and the end time input box is provided to input or select the end time of the VLL.

In block 602, a request receiving module receives a VLL establishing request generated by an operation on the user interface by the user, the VLL establishing request includes information of the start area, the end area, the start time, and the end time of the VLL. In detail, the operation on the user interface by the user can be the user inputs or selects the start area, the end area, the start time, and the end time respectively via the start input box, the end input box, the start time input box, and the end time input box.

In block 603, a path calculating module determines which router devices are transmission ports constituting the VLL and which ports P of the determined router device are ports to be connected to another port P of other determined router devices, and generate VLL establishing information including the ports to be connected and connection relationships of the router devices determined as the transmission nodes of the VLL.

In block 604, a task assignment module assigns a timed task for the VLL to be established according to the start time and the end time of the VLL, and associates the timed task of the VLL with a VLL identifier code of the VLL and adds the associated timed task and VLL identifier code to a timed task list.

In block 605, a task monitoring module monitors the timed task of each VLL of the timed task list to determine whether current time reaches to the start time of one VLL. If not, the process returns to block 605, if yes, the process jumps to block 606.

In block 606, a path establishing module connects the ports to be connected of the router device determined as the transmission nodes of the corresponding VLL one by one according to the VLL establishing information. In detail, the path establishing module labels the ports to be connected of each router device determined as the transmission node of the VLL by using the VLL identifier code, and connects the ports labeled with the VLL identifier code one by one according to the connection relationships between the router devices determined as the transmission nodes of the VLL.

In the embodiment, the on-demand transmission path providing method further includes: the task monitoring module monitors the timed task of each VLL of the timed task list to determine whether current time reaches to the end time of one VLL; and if the current time reaches to the end time of the VLL, the path establishing module controls to cancels the VLL.

In one embodiment, the user interface further includes a bandwidth input box provided to input or select a bandwidth for the VLL to be established, the on-demand transmission path providing method further includes: the request receiving module receives a bandwidth input or selected by the user; the task assignment module adds the bandwidth to the timed task of the corresponding VLL; and the path establishing module configures the ports to be connected according to the bandwidth of the VLL included in the timed task of the VLL to ensure the ports to be connected to provide the corresponding bandwidth.

In one embodiment, the on-demand transmission path providing method further includes: the task assignment module changes the start time and/or the end time of one VLL of the timed task list TL in response to a change request for changing the start time and the end time of the VLL from the user; the path establishing module controls to establish the VLL or cancel the VLL according to the changed start time and/or the end time of the VLL.

In one embodiment, the on-demand transmission path providing method further includes: the task assignment module changes the bandwidth of one VLL of the timed task list in response to a change request for changing the bandwidth of the VLL from the user; the path establishing module reconfigures the ports to be connected according to the changed/updated bandwidth of the VLL included in the timed task of the VLL to ensure the VLL to provide the changed bandwidth.

In one embodiment, the on-demand transmission path providing method further includes: a transmission controlling module labels data transmitted by the user by using the VLL identifier code, and control the data to transmit via the ports labeled with the same VLL identifier code when transmitting the data via the router device constituting the VLL.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An on-demand transmission path providing system, configured to establish one or more virtual lease lines (VLLs), the system comprising:
at least one processor; and
a plurality of modules which are collections of instructions executed by the processor, the plurality of modules comprising:
an interface providing module configured to provide a user interface for a user to input a start area, an end area, a state time, and an end time of a VLL to be established;
a request receiving module configured to receive a VLL establishing request generated by an operation on the user interface by the user, the VLL establishing request comprising information of the start area, the end area, the start time, and the end time of the VLL;
a path calculating module configured to determine which router devices are transmission ports constituting the VLL and which ports of a router device determined as transmission nodes of the VLL are ports to be connected to another port of other router devices determined as the transmission nodes of the VLL, and generate VLL establishing information comprising the ports to be connected and connection relationships of the router devices determined as the transmission nodes of the VLL;
a task assignment module configured to assign a timed task for the VLL to be established according to the start time and the end time of the VLL, and associate the timed task of the VLL with a VLL identifier code of the VLL and add the associated timed task and VLL identifier code to a timed task list, wherein the timed task for the VLL comprises the start time and the end time of the VLL;
a task monitoring module configured to monitor the timed task of each VLL of the timed task list to determine whether a current time reaches a start time of the VLL; and
a path establishing module configured to connect the ports to be connected of the router device determined as the transmission nodes of the corresponding VLL one by one according to the VLL establishing information if the current time reaches to the start time of the VLL.

2. The system according to claim 1, wherein the path establishing module labels the ports to be connected of each router device determined as the transmission node of the VLL by using the VLL identifier code, and connects the ports labeled with the VLL identifier code one by one according to the connection relationships of the router devices determined as the transmission nodes of the VLL.

3. The system according to claim 1, wherein the task monitoring module is further configured to monitor the timed task of each VLL of the timed task list to determine whether current time reaches to the end time of one VLL; and the path establishing module is further configured to cancels the VLL if the current time reaches to the end time of the VLL.

4. The system according to claim 3, wherein the task assignment module is further configured to change the start time and/or the end time of one VLL of the timed task list in response to a change request for changing the start time and the end time of the VLL from the user; the path establishing module controls to establish the VLL or cancel the VLL according to the changed start time and/or the end time of the VLL.

5. The system according to claim 1, wherein the user interface further comprises a bandwidth input box provided to input or select a bandwidth for the VLL to be established; the timed task assigned by the task assignment module further comprises the bandwidth of the VLL to be established, and the path establishing module configures the ports to be connected to ensure the ports to provide the corresponding bandwidth according to the bandwidth of the VLL comprised in the timed task of the VLL.

6. The system according to claim 5, wherein the task assignment module is further configured to change the bandwidth of one VLL of the timed task list in response to a change request for changing the bandwidth of the VLL from the user, the path establishing module reconfigures the ports to be connected according to the changed bandwidth of the VLL, thus to ensure the VLL to provide the changed bandwidth.

7. The system according to claim 1, wherein the path establishing module is further configured to establish a connection between the router device located in the start area and a terminal device of the user generating the VLL establishing request, and establish a connection between the router device located in the end area and a target object.

8. The system according to claim 1, wherein the modules further comprises a transmission controlling module configured to label data transmitted by the user by using the VLL identifier code, and control the data to transmit via the ports labeled with the same VLL identifier code when transmitting the data via the router devices constituting the VLL.

9. An on-demand transmission path providing method, configured to establish a virtual leas line (VLL), the method comprising:
providing a user interface provided for a user to input a start area, an end area, a state time, and an end time of a VLL to be established;
receiving a VLL establishing request generated by an operation on the user interface by the user, the VLL establishing request comprising information of the start area, the end area, the start time, and the end time of the VLL;
determining which router devices are transmission ports constituting the VLL and which ports of the router device determined as the transmission nodes of the VLL are ports to be connected to another port of other router devices determined as the transmission nodes of the VLL, and generating VLL establishing information comprising the ports to be connected and connection relationships of the router devices determined as the transmission nodes of the VLL;
assigning a timed task for the VLL to be established according to the start time and the end time of the VLL, and associating the timed task of the VLL with a VLL identifier code of the VLL and adding the associated timed task and VLL identifier code to a timed task list, wherein the timed task for the VLL comprises the start time and the end time of the VLL;
monitoring the timed task of each VLL of the timed task list to determine whether current time reaches to the start time of one VLL; and
connecting the ports to be connected of the router device determined as the transmission nodes of the corresponding VLL one by one according to the VLL establishing information if the current time reaches to the start time of the VLL.

10. The method according to claim 9, wherein the step of connecting the ports to be connected of the router device determined as the transmission nodes of the corresponding VLL one by one according to the VLL establishing information if the current time reaches to the start time of the VLL comprising:
labeling the ports to be connected of each router device determined as the transmission node of the VLL by using the VLL identifier code; and
connecting the ports labeled with the VLL identifier code one by one according to the connection relationships of the router devices determined as the transmission nodes of the VLL.

11. The method according to claim 9, further comprising:
monitoring the timed task of each VLL of the timed task list to determine whether current time reaches to the end time of one VLL; and
cancelling the VLL if the current time reaches to the end time of the VLL.

12. The method according to claim 11, further comprising:
changing the start time and/or the end time of one VLL of the timed task list in response to a change request for changing the start time and the end time of the VLL from the user; and
controlling to establish the VLL or cancelling the VLL according to the changed start time and/or the end time of the VLL.

13. The method according to claim 9, wherein the user interface further comprises a bandwidth input box provided to input or select a bandwidth for the VLL to be established, the timed task assigned by the task assignment module further comprises the bandwidth of the VLL to be established, the method further comprising:
configuring the ports to be connected to ensure the ports to provide the corresponding bandwidth according to the bandwidth of the VLL comprised in the timed task of the VLL.

14. The method according to claim 13, further comprising:
changing the bandwidth of one VLL of the timed task list in response to a change request for changing the bandwidth of the VLL from the user; and
reconfiguring the ports to be connected according to the changed bandwidth of the VLL, thus to ensure the VLL to provide the changed bandwidth.

15. The method according to claim 9, further comprising:
establishing a connection between the router device located in the start area and a terminal device of the user generating the VLL establishing request; and
establishing a connection between the router device located in the end area and a target object.

16. The method according to claim 9, further comprising:
labeling data transmitted by the user by using the VLL identifier code; and
controlling the data to transmit via the ports labeled with the same VLL identifier code when transmitting the data via the router devices constituting the VLL.

17. A non-transitory storage medium having stored thereon instructions that, when executed by at least one processor of a computing device, causes the least one processor to execute instructions of a method for automatically establishing a virtual leas line (VLL), the method comprising:
providing a user interface provided for a user to input a start area, an end area, a state time, and an end time of a VLL to be established;
receiving a VLL establishing request generated by an operation on the user interface by the user, the VLL establishing request comprising information of the start area, the end area, the start time, and the end time of the VLL;
determining which router devices are transmission ports constituting the VLL and which ports of the router device determined as the transmission nodes of the VLL are ports to be connected to another port of other router devices determined as the transmission nodes of the VLL, and generating VLL establishing information comprising the ports to be connected and connection relationships of the router devices determined as the transmission nodes of the VLL;
assigning a timed task for the VLL to be established according to the start time and the end time of the VLL, and associating the timed task of the VLL with a VLL identifier code of the VLL and adding the associated timed task and VLL identifier code to a timed task list, wherein the timed task for the VLL comprises the start time and the end time of the VLL;
monitoring the timed task of each VLL of the timed task list to determine whether current time reaches to the start time of one VLL; and
connecting the ports to be connected of the router device determined as the transmission nodes of the corresponding VLL one by one according to the VLL establishing information if the current time reaches to the start time of the VLL.

18. The non-transitory storage medium according to claim 17, wherein the step of connecting the ports to be connected of the router device determined as the transmission nodes of the corresponding VLL one by one according to the VLL establishing information if the current time reaches to the start time of the VLL comprising:
labeling the ports to be connected of each router device determined as the transmission node of the VLL by using the VLL identifier code; and
connecting the ports labeled with the VLL identifier code one by one according to the connection relationships of the router devices determined as the transmission nodes of the VLL.

19. The non-transitory storage medium according to claim 17, further comprising:
monitoring the timed task of each VLL of the timed task list to determine whether current time reaches to the end time of one VLL; and
cancelling the VLL if the current time reaches to the end time of the VLL.

20. The non-transitory storage medium according to claim 19, further comprising:
changing the start time and/or the end time of one VLL of the timed task list in response to a change request for changing the start time and the end time of the VLL from the user; and
controlling to establish the VLL or cancelling the VLL according to the changed start time and/or the end time of the VLL.
